(19) United States
(12) Patent Application Publication
(10) Pub. No.: US 2006/0061201 A1
(43) Pub. Date: Mar. 23, 2006

(54) Seat belt restraint and alarm system and method of use thereof

(76) Inventor: Charles W. Skinner, Duluth, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/945,667

(22) Filed: Sep. 21, 2004

(51) Int. Cl. B60R 22/48

(52) U.S. Cl. 297/468

(57) ABSTRACT

A seat belt restraint and alarm system and method of use thereof, comprising electronic circuitry within an automobile key. Upon activation via coupling of a seat belt, removal of the alert beyond a selected distance from a vehicle will result in activation of an alarm advising a parent or other caregiver that a child is still secured within the vehicle. A vehicular transmitter/receiver senses the presence or absence of a circuit component or a signal from the key-borne device and if absent, signals back to sound the alarm.

### TECHNICAL FIELD

The present invention relates generally to alarm systems, and more specifically to a seat belt restraint and alarm system and method of use thereof, wherein the alert activates when the car keys are transported past the perimeter of a pre-defined area surrounding the car in order to alert the driver that a child is still in the car.

### BACKGROUND OF THE INVENTION

Increasingly, parents are becoming forgetful of their children, often unintentionally leaving them unattended in vehicles. Stressful daily lives with many tasks to perform cause a parent, or other person transporting children, to become distracted and inadvertently leave children upon departing a vehicle. Occasionally, the vehicle is shuttered and locked, even in hot weather, thereby potentially causing severe distress, injury, and/or death of a child left therein. In addition to injuries, children left alone in an otherwise unoccupied vehicle are potentially subject to kidnapping. With the need for multitasking, wherein many different needs are being addressed, and the consequent straining of the ability of a parent or caregiver to remember while busy and stressed, some form of reminding device would be advantageous. Unfortunately, there is nothing available to remind the parent or caregiver of the fact that a child has been left in a vehicle.

More and more, children are transported in bulk, such as in school buses. Many other children attend day care facilities that utilize transport vans to carry the children to and from their home. With no headcount controls, the drivers of such vehicles may believe that all children have exited the vehicle and be unaware upon leaving the vehicle that a child remains behind.

Therefore, it is readily apparent that there is a need for a seat belt restraint and alarm system and method of use thereof, wherein a parent or other caregiver who is leaving the vicinity of a vehicle is reminded of the fact that the seat belt securing the child, or the child's seat, is still engaged and that a potentially hazardous condition exists for the child.

### BRIEF SUMMARY OF THE INVENTION

Briefly described, in a preferred embodiment, the present invention overcomes the above-mentioned disadvantages and meets the recognized need for such a device by providing a seat belt restraint and alarm system and method of use thereof, wherein a parent or other caregiver transporting the child is notified that she/he is leaving the vicinity of the vehicle while the seat belt securing the child is still latched. Such notification is provided by a device that is likely to be carried away from the vehicle by the parent or caregiver, such as a key or key fob, thereby providing both a mechanism for sensing that the parent/caregiver is leaving the area of the vehicle and that they have not removed his/her child from the vehicle.

According to its major aspects and broadly stated, the present invention in its preferred form is a seat belt restraint and alarm system comprising an alerting device that is compact and likely to be transported by the driver of the vehicle. Since it is entirely likely that the parent or caregiver will take the vehicle key and retain possession thereof, the present invention includes an alert/alarm and sensing mechanism incorporated into or with the key, wherein transport of the key away from the vehicle a selected distance results in activation of the alert/alarm. A transmitter within the vehicle is activated by the latching of the seat belt, and functions to communicate with the sensing mechanism disposed on or with the car key.

More specifically, the present invention is a seat belt restraint and alarm system and method of use thereof, wherein an automobile key, key fob, or remote security device, contains therein a sensing and/or signaling mechanism activated upon transport of the key beyond a selected distance from the vehicle. That is, movement or transport of the key beyond this selected distance is sensed by the sensing mechanism disposed therewith, resulting in activation of an audible, visual and/or tactually-sensed alarm. In a preferred embodiment, the sensing mechanism is a circuit component in electrical communication with a transmitting component in the vehicle. The vehicular transmitting component is activated by a switch engaged by latching of a seat belt around a child or child seat, wherein the seat belt latch comprises two halves, typically a tab and a buckle. The switch is preferably contained within the buckle and activated by insertion of the tab. The activation of the switch is preferably by physical contact of the tab, but alternately could be optical or magnetic. Thus, if the seat belt is not unfastened and remains latched, the system will remain armed, but if the seat belt is disengaged to remove the child from the car, the system will be deactivated.

If the seat belt is not unfastened and the transmitting component does not detect the presence of the circuit component which has exited the perimeter area, a signal is sent to activate the alert/alarm disposed with the car key. The circuit component interacts with the transmitting component sending the signal, such as by creating a field disturbance, via transmitting a signal and/or via induction. Upon removal of the circuit component from the circuit, the transmitting component forming the circuit detects the lack of the circuit component, and subsequently transmits a signal to activate a receiver/alarm within the key and/or key fob. Alternately, a transmitter could be contained within the key or key fob that provides a signal received by a vehicular transceiver.

Accordingly, a feature and advantage of the present invention is its ability to alert a parent or other caregiver that they have left their child strapped into a seat belt or child seat within the car interior.

Another feature and advantage of the present invention is its ability to save lives.

Still another feature and advantage of the present invention is its ability to warn a driver that they have reached a selected distance from a vehicle.

Yet another feature and advantage of the present invention is that it incorporates and utilizes the key or key fob typically carried by the driver of an automobile.

Yet still another feature and advantage of the present invention is its convenience.

A further feature and advantage of the present invention is its ability to be retrofitted to existing vehicles and associated car keys and/or key fobs.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a seat belt restraint and alarm system according to a preferred embodiment of the present invention;

FIG. 2A is a perspective view of seat belt components of a seat belt restraint and alarm system according to a preferred embodiment of the present invention;

FIG. 2B is a top plan view of a key component of a seat belt restraint and alarm system according to a preferred embodiment of the present invention; and

FIG. 3 is a perspective view of a key holder component of a seat belt restraint and alarm system according to an alternate embodiment of the present invention.

### DETAILED DESCRIPTION OF THE PREFERRED AND SELECTED ALTERNATIVE EMBODIMENTS

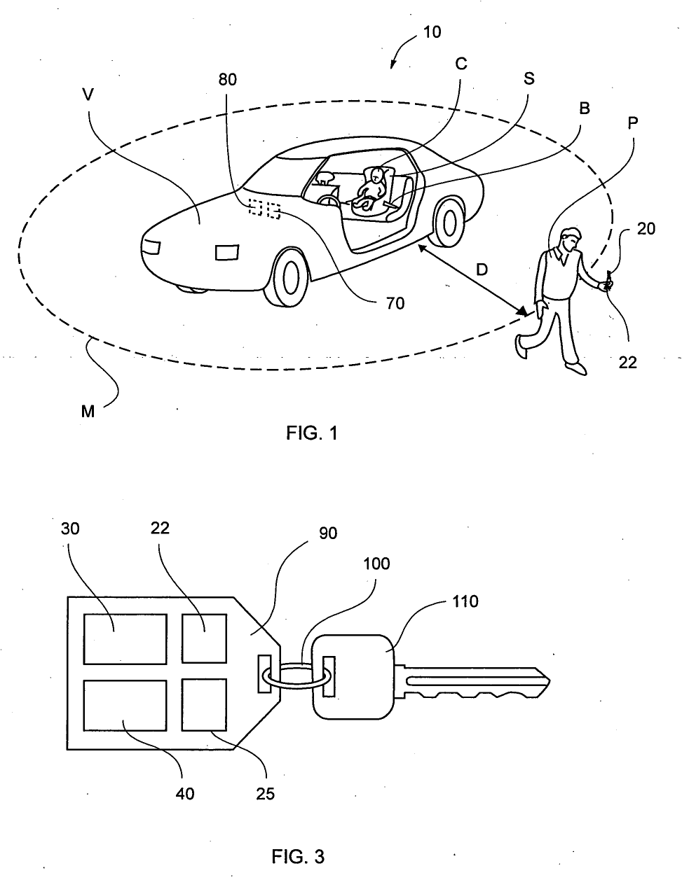

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

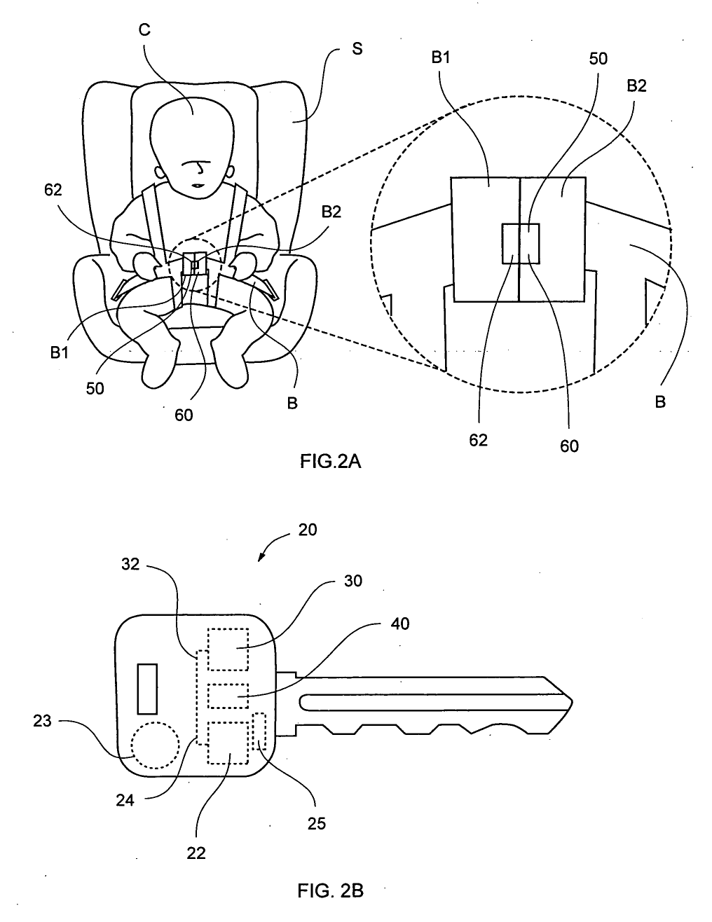

Referring now to FIGS. 1-2B, the present invention in a preferred embodiment is seat belt restraint and alarm system 10 preferably comprising alarm-equipped key 20, wherein alarm-equipped key 20 preferably comprises receiver 22, battery 23, alarm 30 and distance sensing mechanism 40 for detecting a predefined distance D from vehicle V. Receiver 22 is preferably in electrical communication with alarm 30 via connector 32, wherein alarm 30 preferably comprises any suitable alarming device, such as, for exemplary purposes only, a buzzer, speaker, vibrator or light. Battery 23 could be a primary cell replaceable upon expiration or could alternately comprise a rechargeable cell.

Vehicle V preferably has therein child seat S, wherein child C is preferably placed therein prior to operation of vehicle V. Alternately, for older children, child C may reside within vehicle V without additional child seat S. Child C or child seat S is preferably held securely within vehicle via seat belt B. Seat belt B preferably contains therein, or thereon, mechanism 50 for detecting or determining whether seat belt B is in latched condition. Preferably, mechanism 50 comprises switch 60, wherein switch 60 is preferably activated by connection of component halves B1 and B2 of seat belt B, and wherein component half B1 preferably comprises a tab, and wherein component half B2 preferably comprises a buckle. Switch 60 is preferably in electrical communication with control transceiver 70 of vehicle V.

Upon latching of component halves B1 and B2, switch 60 is preferably activated thereby and sends a signal via switch transmitter 62 to control transceiver 70, wherein switch transmitter 62 is preferably in electrical communication with control transceiver 70. Electrical communication between switch transmitter 62 and control transceiver 70 is preferably accomplished by hard-wired connection, but alternately an optical signal or radio frequency signal could be utilized. The signal can be continuous, or switch 60 can be polled by control transceiver 70 within vehicle V indicating that seat belt B is latched. During periods when switch 60 is in an activated state indicating that seat belt B is latched, control transceiver 70 preferably polls or otherwise detects the presence of distance sensing mechanism 40. So long as means for sensing distance is present or resides within predefined distance D from vehicle V, preferably no alarm signal is sent. If distance sensing mechanism 40 is absent or moved beyond or through perimeter M defined by distance D, control transceiver 70 preferably transmits a signal to activate alarm 30 and/or sounds vehicular alarm 80, wherein control transceiver 70 and vehicular alarm 80 are preferably in electrical communication.

Distance sensing mechanism 40 of seat belt restraint and alarm system 10 preferably interacts with circuitry located in vehicle V as an un-powered passive component. Such a component preferably comprises an inductor or a means for creating a field disturbance, the presence of which is detectable by control transceiver 70 preferably located within a suitable distance from distance sensing mechanism 40. It will be recognized by those skilled in the art that means other than an inductor could be utilized without departing from the present invention.

Upon removal or transport of distance sensing mechanism 40 outside of range/distance D of control transceiver 70, the absence of distance sensing mechanism 40 is preferably sensed by control transceiver 70, wherein control transceiver 70 subsequently preferably activates vehicular alarm 80 and/or transmits a signal to activate key alarm 30 within alarm-equipped key 20 via receiver 22.

In operation, child C is preferably placed into child seat S, wherein child seat S is preferably strapped in via seat belt B, or, alternately, older child C is strapped in via seat belt B. Connection of seat belt halves B1 and B2 preferably mechanically activates switch 60. It will be recognized by those skilled in the art that activating means other than mechanical could be utilized to activate switch 60, such as for exemplary purposes only, Hall Effect switching.

Upon exiting vehicle V, parent P preferably transports alarm-equipped key 20 away from vehicle V. Upon reaching distance D from vehicle V, or upon breaching perimeter M, control transceiver 70 preferably detects absence of distance sensing mechanism 40, activates vehicular alarm 80, and/or sends signal to alarm-equipped key 20, wherein signal is preferably received by receiver 22. Receiver 22 preferably activates alarm 30, thereby indicating to parent P that child C is still strapped in vehicle V via seat belt B.

In an alternate embodiment of the present invention, alarm-equipped key 20 could further comprise transceiver 25 in addition to receiver 22, wherein transceiver 25 broadcasts a signal suitable for reception by control transceiver 70 located within vehicle V. Upon activation of switch 60, thereby indicating that seat belt B is latched, control transceiver 70 could poll transceiver 25 and receive a response therefrom, or alternately transceiver 25 could continuously broadcast a signal. Alternately, transceiver 25 could intermittently broadcast according to a pre-selected time interval. Upon removal of transceiver 25 beyond its transmitting and/or receiving range, control transceiver 70 could detect the absence of a signal from transceiver 25 and could activate vehicular alarm 80 and/or alarm 30 only if the signal from transceiver 25 was absent; thereby, confirming that seat belt B is latched.

Referring now more specifically to FIG. 3, illustrated therein is an alternate embodiment of seat belt restraint and alarm system 10, wherein the alternate embodiment of FIG. 3 is substantially equivalent in form and function to that of the preferred embodiment detailed and illustrated in FIGS. 1-2B except as hereinafter specifically referenced. Specifically, the embodiment of FIG. 3 comprises holder 90, wherein holder 90 comprises key chain remote control holder 90. Key 110 is removably attached to holder 90 via retainer 100, wherein holder 90 comprises receiver 22, alarm 30, distance sensing mechanism 40 and, alternately, transceiver 25, and wherein receiver 22, alarm 30, distance sensing mechanism 40 and transceiver 25 function as described hereinabove for the preferred embodiment of the present invention.

In a further alternate embodiment of the present invention, battery 23 within alarm-equipped key 20 could be recharged from electrical power onboard vehicle V while alarm-equipped key 20 is engaged within vehicle V, wherein power for said recharging could be transferred either via direct electrical contact or via induction.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A seat belt restraint and alarm system comprising:
a portable alarm.

2. The seat belt restraint and alarm system of claim 1, further comprising:
a means for sensing seat belt engagement;

3. The seat belt restraint and alarm system of claim 2, further comprising:
a means for sensing distance from a vehicle; and

4. The seat belt restraint and alarm system of claim 3, further comprising:
a means for activating said portable alarm.

5. The seat belt restraint and alarm system of claim 4, wherein said means for sensing distance is in communication with said means for activating said portable alarm.

6. The seat belt restraint and alarm system of claim 3, wherein said means for sensing seat belt engagement is in communication with said means for sensing distance from said vehicle.

7. The seat belt restraint and alarm system of claim 4, wherein said means for sensing seat belt engagement is in communication with said means for activating said portable alarm.

8. The seat belt restraint and alarm system of claim 2, further comprising a seat belt having component halves, wherein said means for sensing seat belt engagement comprises a switch device, wherein said switch device is activated via engagement of said component halves of said seat belt.

9. The seat belt restraint and alarm system of claim 8, wherein said switch device is contained within one of said component halves of said seat belt.

10. The seat belt restraint and alarm system of claim 1, wherein said portable alarm is contained within an automobile key.

11. The seat belt restraint and alarm system of claim 1, wherein said portable alarm is contained within an automobile key holder.

12. The seat belt restraint and alarm system of claim 3, wherein said means for sensing distance from a vehicle is contained within an automobile key.

13. The seat belt restraint and alarm system of claim 3, wherein said means for sensing distance from a vehicle is contained within an automobile key holder.

14. The seat belt restraint and alarm system of claim 3, wherein said means for sensing distance from a vehicle comprises a portable circuit component comprising means for determining breach of a perimeter by said portable circuit component.

15. The seat belt restraint and alarm system of claim 14, wherein said means for determining breach of a perimeter activates an alarm if said portable circuit component is missing from an area defined by said perimeter.

16. The seat belt restraint and alarm system of claim 14, wherein said means for determining breach of a perimeter activates if said portable circuit component passes through said perimeter.

17. The seat belt restraint and alarm system of claim 14 wherein said means for determining breach of a perimeter comprises means for determining lack of signal from a transceiver.

18. The seat belt restraint and alarm system of claim 3, wherein said means for sensing distance from a vehicle comprises a portable transceiver in communication with a vehicular receiver.

19. A method of providing a reminder that a child is still in a vehicle, said method comprising the steps of:
obtaining a seat belt restraint and alarm, said seat belt restraint and alarm comprising a portable alarm.

20. The method of claim 19, wherein said seat belt restraint and alarm comprises a means for sensing seat belt engagement.

21. The method of claim 19, wherein said seat belt restraint and alarm comprises a means for sensing distance from a vehicle.

22. The method of claim 19, wherein said seat belt restraint and alarm comprises a means for activating said portable alarm.

23. The method of claim 19, further comprising the step of:
securing a child in the vehicle via a seat belt.

24. The method of claim 19, further comprising the step of:
leaving an area surrounding the vehicle; and

25. The method of claim 19, further comprising the step of:
activating said seat belt restraint and alarm.

26. The method of claim 23, wherein said step of securing a child in a vehicle via a seat belt comprises placing a child in a child seat and securing said child seat and child via the seat belt.

27. The method of claim 26, further comprising the step of
signaling that the seat belt is engaged.

28. An apparatus for signaling that a child is secured within a seat belt, said apparatus comprising:
a portable alarm, wherein said portable alarm is contained within an automobile key.

29. The apparatus for signaling of claim 28, further comprising a means for sensing seat belt engagement;

30. The apparatus for signaling of claim 28, further comprising a means for sensing distance from a vehicle; and

31. The apparatus for signaling of claim 28, further comprising a means for activating said portable alarm.
